(19) United States
(12) Patent Application Publication
(10) Pub. No.: US 2007/0050587 A1
(43) Pub. Date: Mar. 1, 2007

(54) Providing security for storage units

(76) Inventors: Sriram Palapudi, Santa Clara, CA (US); Maria Savarimuthu Rajakannimariyan, San Jose, CA (US)

Correspondence Address: KONRAD RAYNES & VICTOR, LLP.;ATTN: IBM37, 315 SOUTH BEVERLY DRIVE, SUITE 210, BEVERLY HILLS, CA, 90212, US

(21) Appl. No.: 11/215,190

(22) Filed: Aug. 29, 2005

(51) Int. Cl. G06F 12/00

(52) U.S. Cl. 711/164

(57) ABSTRACT

Provided are a method, system and article of manufacture, wherein a password that corresponds to at least one logical unit is assigned in a storage system. A request is received from a requestor to perform an operation on the at least one logical unit. The requestor is authenticated for a limited period of time, in response to the requester providing the assigned password for the at least one logical unit. The operation is performed on the at least one logical unit, in response to authenticating the requestor.

### BACKGROUND

1. Field

The disclosure relates to a method, system, and article of manufacture for providing security for storage units.

2. Background

A storage system may be coupled to a physical storage, where a plurality of logical units provide a logical representation of the physical storage. The logical units are addressable from applications that execute in the storage system, and from other applications that execute in hosts that are coupled to the storage system over a network.

Different groups of logical units may be assigned to different hosts, and applications that run on a host may be capable of accessing those logical units that have been assigned to the host. Additionally, a plurality of users may access the logical units from a single host. Furthermore, in certain computing environments, a storage administrator may maintain the storage system. The storage administrator may have access to the logical units coupled to the storage system.

Access control lists (ACL) maintained on the storage system may be used to determine which hosts can access a logical unit. Providing security via the access control lists may allow the logical units on the storage system to be protected from access from unauthorized hosts.

### SUMMARY OF THE DESCRIBED EMBODIMENTS

Provided are a method, system and article of manufacture, wherein a password that corresponds to at least one logical unit is assigned in a storage system. A request is received from a requestor to perform an operation on the at least one logical unit. The requestor is authenticated for a limited period of time, in response to the requestor providing the assigned password for the at least one logical unit. The operation is performed on the at least one logical unit, in response to authenticating the requester.

In certain embodiments, the request is generated from within the storage system, wherein the operation is for copying the at least one logical unit, and wherein the limited period of time expires in response to an expiry of a session.

In additional embodiments, the request is generated by the requestor from at least one host coupled to the storage system, wherein the operation is for performing input/output (I/O) on the at least one logical unit, and wherein the limited period of time expires in response to an expiry of a session.

In further embodiments, the request is generated from at least one host by the requestor. An access control list corresponding to the at least one logical unit is maintained, wherein an entry in the access control list is capable of being used to determine whether the at least one host can access the at least one logical unit. The requestor is authenticated for the limited period of time, even if the entry in the access control list has been used to determine that the at least one host is capable of accessing the at least one logical unit.

In still further embodiments, a plurality of logical units that includes the at least one logical unit in the storage system is generated. A single password is assigned for a group of logical units selected from the plurality of logical units, wherein the requester is authenticated for performing operations on the group of logical units by providing the single password.

In additional embodiments, the at least one logical unit includes a plurality of logical volumes generated from a plurality of physical volumes that comprise physical storage coupled to the storage system, wherein the storage system maintains a first indicator corresponding to the at least one logical unit, and wherein the first indicator indicates whether the password has to be set for the at least one logical unit. The storage system also maintains a second indicator corresponding to the at least logical unit, wherein the second indicator includes the assigned password.

### BRIEF DESCRIPTION OF THE DRAWINGS

Referring now to the drawings in which like reference numbers represent corresponding parts throughout:

FIG. 1 illustrates a block diagram of a computing environment in accordance with certain embodiments;

FIG. 2 illustrates a flowchart for setting passwords for logical units, in accordance with certain embodiments;

FIG. 3 illustrates a flowchart for performing Input/Output (I/O) operations on password protected logical units, in accordance with certain embodiments;

FIG. 4 illustrates a flowchart for performing copy services on password protected logical units, in accordance with certain embodiments;

FIG. 5 illustrates a flowchart for providing security for logical units, in accordance with certain embodiments; and

FIG. 6 illustrates the architecture of computing system, wherein in certain embodiments the hosts and the storage system of the computing environment of FIG. 1 may be implemented in accordance with the architecture of the computing system.

### DETAILED DESCRIPTION

In the following description, reference is made to the accompanying drawings which form a part hereof and which illustrate several embodiments. It is understood that other embodiments may be utilized and structural and operational changes may be made. For example, while the following description describes embodiments with reference to a backup of data, it is understood that alternative embodiments may be utilized for archiving of data, migration of data, etc.

In storage systems it is possible to create logical units and assign the logical units to hosts. Even when an application starts using the logical units and writes application specific data to the logical units, it may be possible for the storage administrator to generate copies of the logical units. It is therefore possible to assign the original logical units or the copied logical units to other systems and the security of the logical units may not be guaranteed with access control lists. In certain situations, such as in data centers where the data corresponding to a plurality of customers may be maintained on a common storage system, access control lists may not be adequate for providing security.

Certain embodiments provide protection of logical units based on a scheme that provides Input/Output (I/O) and copy services access to logical units by using a password protection mechanism.

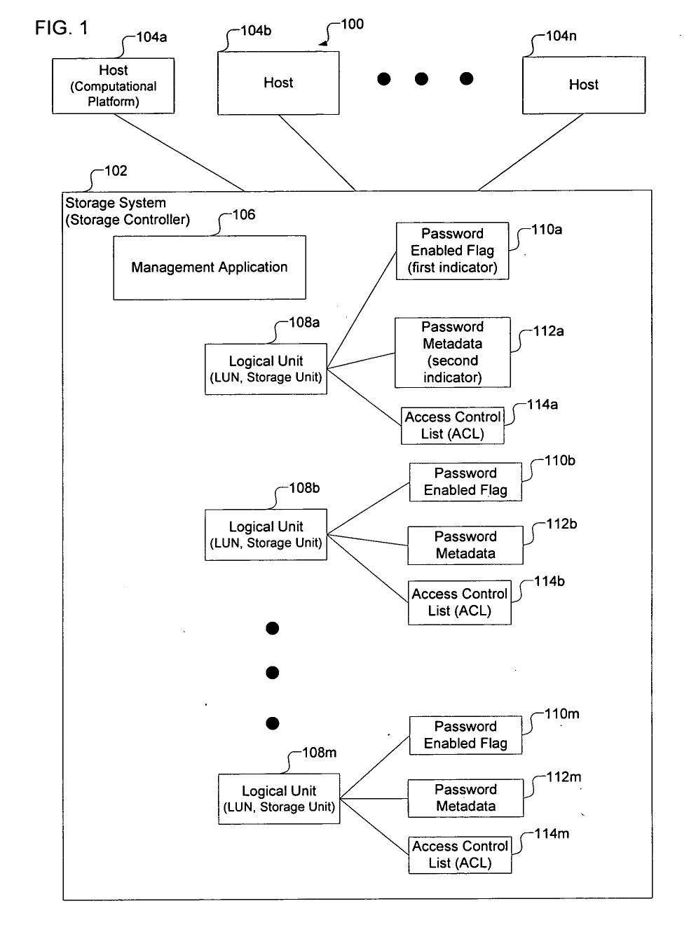

FIG. 1 illustrates a block diagram of a computing environment 100 in accordance with certain embodiments. At least one storage system 102, where in certain embodiments the storage system 102 may comprise a storage controller, is coupled via a network to a plurality of computational platforms 104a, 104b, . . . ,104n, where in certain embodiments the plurality of computational platforms 104a . . . 104n may comprise hosts.

The storage system 102 and the hosts 104a . . . 104n may comprise any suitable computational platform, including those presently known in the art, such as, personal computers, workstations, mainframes, midrange computers, network appliances, palm top computers, telephony devices, blade computers, laptop computers, etc. Embodiments may be implemented in a computing environment that is based on a client-server paradigm. Alternative embodiments may be implemented in a peer-to-peer networked environment or any other networked environment. The coupling of the hosts 104a . . . 104n to the storage system 102 may be direct or may be via any network known in the art, such as a Storage Area Network (SAN), Local Area Network (LAN), Wide Area Network (WAN), the Internet, an Intranet, etc.

The storage system 102 includes a management application 106 and a plurality of logical units 108a, 108b, . . . ,108m. The management application 106 may interact with applications on the hosts 104a . . . 104n and control the logical units 108a . . . 108m. While a single management application 106 is shown, in alternative embodiments the operations performed by the management application 106 may be performed by a plurality of applications, such as separate authentication tools, applications that provide command line interfaces, etc.

The plurality of logical units 108a . . . 108m may include logical volumes, where the logical volumes are logical representations of physical volumes corresponding to physical storage coupled to the storage system 102. While data is physically stored in the physical volumes that comprise the physical storage, applications that execute on the storage system 102, and the hosts 104a . . . 104n may address the logical units 108a . . . 108m and the logical volumes included in the logical units 108a . . . 108m. A logical unit may also be referred to as a LUN. A logical unit may comprise any addressable unit of storage that may be addressed by applications.

Associated with the logical units 108a, 108b, . . . ,108m are data structures representing password enabled flags 110a, 110b, . . . ,110m, password metadata 112a, 112b, . . . ,112m, and access controls lists 114a, 114b, . . . 114m. For example, password enabled flag 110a, password metadata 112a, and access control list 114a are associated with the logical unit 108a.

A password enabled flag, such as password enabled flag 110a, indicates whether password protection has been enabled for the corresponding logical unit. If the password enabled flag is set then password protection is enabled for the corresponding logical unit and if the password protection flag is not set then password protection is disabled for the corresponding logical unit.

Password metadata, such as password metadata 112a, stores the password used to protect the logical unit from unauthorized users and applications. The password metadata may be used for checking a password if the password enabled flag is set. If the password enabled flag is set for a particular logical unit, then a user or an application can access the particular logical unit after providing the corresponding password for the particular logical unit stored in the corresponding password metadata.

The access control list, such as access control list 114a, maintains entries that can be used to determine which hosts are capable of accessing the logical unit corresponding to the access control list. The entries of the access control list cannot prevent storage system administrators from copying logical units or unauthorized users of a host from accessing logical units assigned to the host.

Therefore, FIG. 1 illustrates certain embodiments in which if a password enabled flag is set for a particular logical unit, then a user or an application can access the particular logical unit after providing the corresponding password for the particular logical unit stored in the corresponding password metadata. As a result, additional security beyond that provided by access control lists is provided in the computing environment 100.

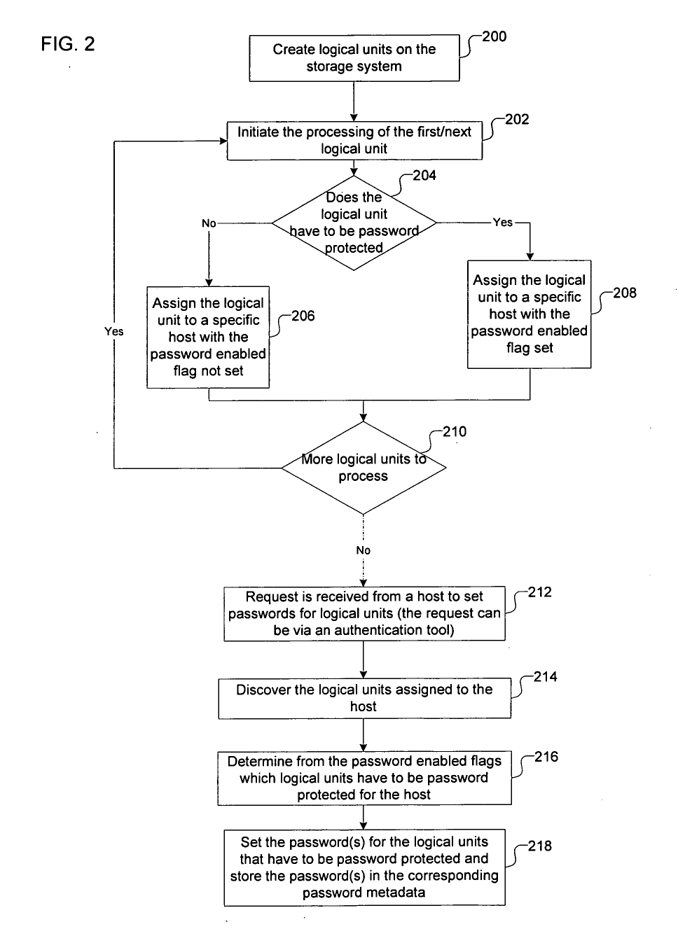

FIG. 2 illustrates a flowchart for setting passwords for logical units 108a . . . 108m, in accordance with certain embodiments. The operations illustrated in FIG. 2 may be implemented in the storage system 102 by the management application 106.

Control starts at block 200, where the management application 106 creates the logical units 108a . . . 108m from physical volumes coupled to the storage system 102. Each logical unit 108a . . . 108m may include a plurality of logical volumes addressable by applications. The logical units 108a . . . 108m may be created in response to a request from an application on a host to assign logical units to the application.

The management application 106 initiates (at block 202) the processing a logical unit that has been created. The management application determines (at block 204) whether the logical unit has to be password protected. It is possible, that certain logical units may include data that may be shared across users and such logical units may not need password protection.

If the management application 106 determines (at block 204) that the logical unit does not have to be password protected, then the management application 106 assigns (at block 206) the logical unit to a specific host with the password enabled flag not set. For example, the management application 106 may not set the password enabled flag 110a for logical unit 108a while assigning the logical unit 108a to the host 104a.

If the management application 106 determines (at block 204) that the logical unit has to be password protected, then the management application 106 assigns (at block 208) the logical unit to a specific host with the password enabled flag set. For example, the management application 106 may set the password enabled flag 110a for logical unit 108a while assigning the logical unit 108a to the host 104a.

Control proceeds to block 210 from blocks 206 and 208, and a determination is made as to whether there are more logical units to process for password protection, If so, control returns to block 202. If not, then a request is received (at block 212) from a host to set passwords for logical units. The request can be via an authentication tool or may be communicated to the management application 106.

In response to receiving the request from a host, the management application 106 discovers (at block 214) the logical units assigned to the host. For example, the management application 106 may determine that the logical units 108a, 108b have been assigned to host 104a.

The management application 106 determines (at block 216) from the password enabled flags which logical units have to be password protected for the host. For example, if logical units 108a, 108b have been assigned to the host 104a, then the management application 106 may determine from the password enabled flags 110a, 110b whether the logical units 108a, 108b have to be password protected.

The management application 106 sets (at block 218) the passwords for the logical units that have to be password protected and stores the passwords in the corresponding password metadata. For example, the management application 106 may have determined that logical unit 108b needs to be password protected and may store the password in the password metadata 112b. The password may be provided by a user or may be generated automatically by an application.

Therefore, FIG. 2 illustrates certain embodiments in which security is provided to logical units 108a . . . 108n, by setting the password enabled flags 110a . . . 110m and populating the corresponding password metadata 112a . . . 112m with passwords.

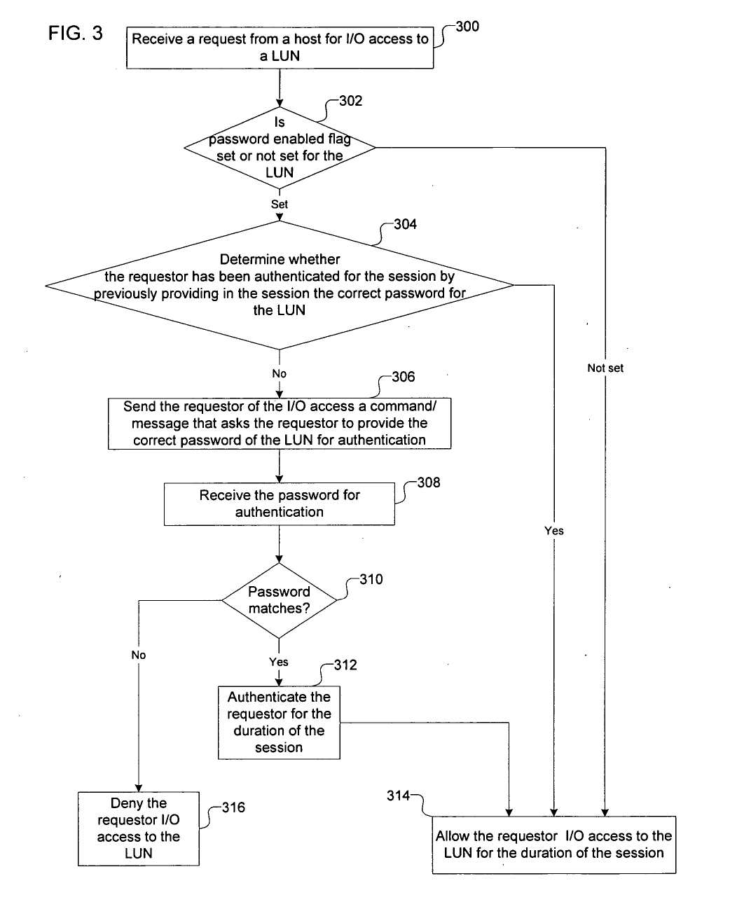

FIG. 3 illustrates a flowchart for performing Input/Output (I/O) operations on password protected logical units 108a . . . 108m, in accordance with certain embodiments. The operations illustrated in FIG. 3 may be implemented in the storage system 102 by the management application 106.

Control starts at block 300 where the management application 106 receives a request from a host for I/O access to a logical unit, such as logical unit 108a. The management application 106 determines (at block 302) whether the password enabled flag, such as password enabled flag 110a, is set or not set for the logical unit. If the password enabled flag is set, then the management application 106 determines (at block 304) whether the requester has been authenticated for the session by previously providing in the session the correct password for the logical unit. If not, the management application 106 sends (at block 306) the requestor of the I/O access a command or a message that asks the requester to provide the correct password of the logical unit for authentication.

The management application 106 receives (at block 308) the password for authentication of the requestor and determines (at block 310) whether the password matches the password stored for the logical unit in the password metadata, such as password metadata 112a. If the password matches, then the management application 106 authenticates (at block 312) the requester for the duration of the session. Control proceeds to block 314, where the management application 106 allows the requester I/O access to the logical unit for the duration of the session.

If at block 310, the management application 106 determines that the password that has been received for authentication of the requester does not match the password stored for the logical unit in the password metadata, then the management application 106 denies (at block 316) the requestor I/O access to the logical unit.

If at block 302, the management application 106 determines that the password enabled flag is not set for the logical unit then control proceeds to block 314 where the management application 106 allows the requester I/O access to the logical unit for the duration of the session. Additionally, if the management application 106 determines (at block 304) that the requestor has been authenticated for the session by previously providing in the session the correct password for the logical unit, then the management application 106 allows (at block 314) the requestor I/O access to the logical unit for the duration of the session.

Therefore, FIG. 3 illustrates certain embodiments in which is which I/O access can be performed on logical units whose password enabled flag is enabled, if the requestor of the I/O access is able to provide the password stored in the corresponding password metadata.

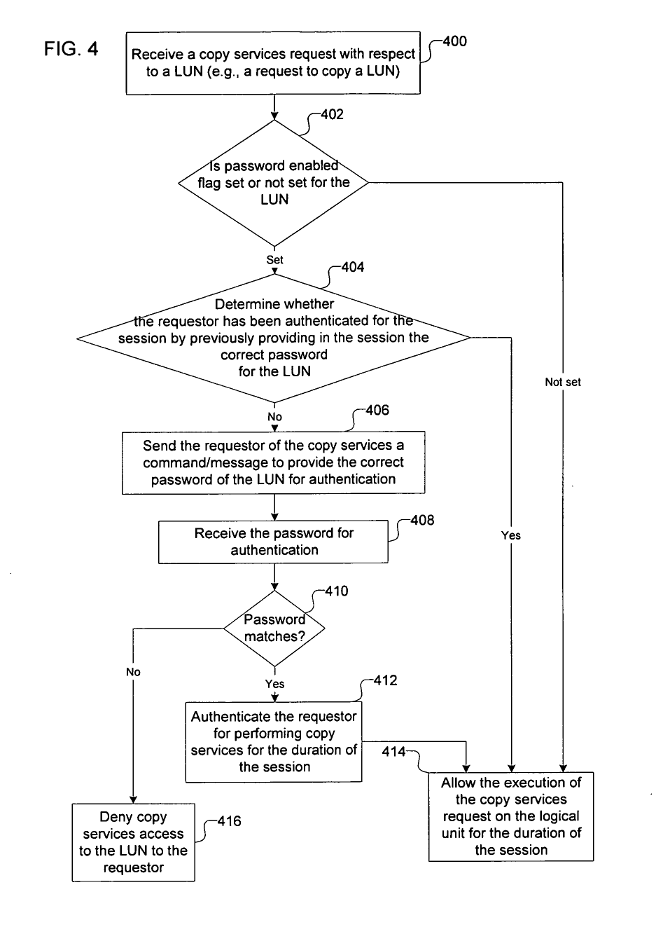

FIG. 4 illustrates a flowchart for performing copy services on password protected logical units 108a . . . 108m, in accordance with certain embodiments. The operations illustrated in FIG. 4 may be implemented in the storage system 102 by the management application 106.

Control starts at block 400 where the management application 106 receives a request from a host for performing copy services with respect to a logical unit, such as logical unit 108a. A copy service request may include a request for copying a logical unit. In certain embodiments, the copy services request may be from a requester that executes a program on a host 104a . . . 104n. In other embodiments, the copy services request may be form a requestor that executes a program on the storage system 102.

The management application 106 determines (at block 402) whether the password enabled flag, such as password enabled flag 110a, is set or not set for the logical unit. If the password enabled flag is set, then the management application 106 determines (at block 404) whether the requestor has been authenticated for the session by previously providing in the session the correct password for the logical unit. If not, the management application 106 sends (at block 406) the requester of the copy services request a command or a message that asks the requester to provide the correct password of the logical unit for authentication.

The management application 106 receives (at block 408) the password for authentication of the requestor and determines (at block 410) whether the password matches the password stored for the logical unit in the password metadata, such as password metadata 112a. If the password matches, then the management application 106 authenticates (at block 412) the requestor for the duration of the session. Control proceeds to block 414, where the management application 106 allows the requester copy services access to the logical unit for the duration of the session.

If at block 410, the management application 106 determines that the password that has been received for authentication of the requestor does not match the password stored for the logical unit in the password metadata, then the management application 106 denies (at block 416) the requestor copy services access to the logical unit.

If at block 402, the management application 106 determines that the password enabled flag is not set for the logical unit then control proceeds to block 414 where the management application 106 allows the requestor access to the logical unit for performing copy services requests for the duration of the session. Additionally, if the management application 106 determines (at block 404) that the requestor has been authenticated for the session by previously providing in the session the correct password for the logical unit, then the management application 106 allows (at block 414) the requester access for performing copy services requests on the logical unit for the duration of the session.

Therefore, FIG. 4 illustrates certain embodiments in which is which copy services requests can be performed on logical units whose password enabled flag is enabled, if the requestor of the copy services request is able to provide the corresponding password stored in the password metadata.

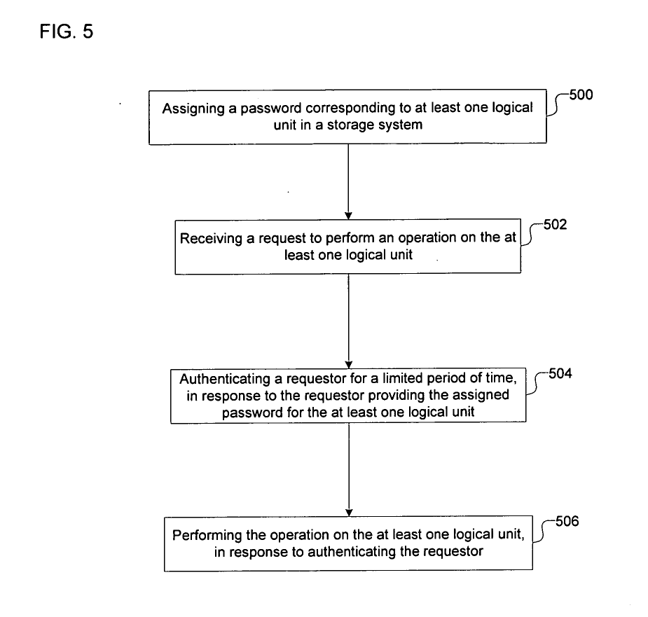

FIG. 5 illustrates a flowchart for providing security for logical units 108a . . . 108m, in accordance with certain embodiments. The operations illustrated in FIG. 5 may be implemented in the storage system 102 by the management application 106.

Control starts at block 500, where the management application 106 assigns a password corresponding to at least one logical unit, such as logical unit 108a, in a storage system 102. The management application 106 receives (at block 502) a request to perform an operation on the at least one logical unit, such as logical 108a. The management application 106 authenticates (at block 504) a requestor for a limited period of time, such as the duration of a session, in response to the requestor providing the assigned password for the at least one logical unit. For example, the requestor may provide the assigned password stored in the password metadata 112a of the logical unit 108a. The requester may be a user or an automated program that generates the request to perform the operations from within the storage system 102, or from any of the hosts 104a . . . 104n. The requester may generate the request from other computational devices that are different from the storage system 102 or the hosts 104a . . . 104n. The management application performs (at block 506) the operation on the at least one logical unit in response to authenticating the requester.

In certain embodiments, the request is generated from within the storage system 102, wherein the operation is for copying the at least one logical unit, and wherein the limited period of time expires in response to an expiry of a session. In certain other embodiments the request is generated by the requestor from at least one host 104a . . . 104n coupled to the storage system 102, wherein the operation is for performing I/O on the at least one logical unit, and wherein the limited period of time expires in response to an expiry of a session.

In additional embodiments an access control list, such as any of the access control lists 114a . . . 114m, corresponding to the at least one logical unit is maintained, wherein an entry in the access control list is capable of being used to determine whether the at least one host can access the at least one logical unit. The requestor is authenticated for the limited period of time, even if the entry in the access control list has been used to determine that the at least one host is capable of accessing the at least one logical unit.

In certain embodiments, a single password is assigned for a group of logical units selected from the plurality of logical units, wherein the requestor is authenticated for performing operations on the group of logical units by providing the single password.

In certain additional embodiments, the at least one logical unit includes a plurality of logical volumes generated from a plurality of physical volumes that comprise physical storage coupled to the storage system 102. A first indicator, such as a password enabled flag 110a . . . 110m corresponding to the at least one logical unit, is maintained in the storage system 102, wherein the first indicator indicates whether the password has to be set for the at least one logical unit. Additionally, a second indicator, such as password metadata 112a . . . 112m corresponding to the at least logical unit is maintained in the storage system 102, wherein the second indicator includes the assigned password.

Certain embodiments, prevent performing I/O requests and copy services with respect to a logical unit, even when the logical unit has been assigned to a host. The security of logical units are enhanced by having password protection in addition to access control lists. A requester may perform certain operations on password protected logical unit by providing the correct password to a management application 106 on a storage system 102. Even administrators of the storage system 102 cannot copy those logical units 108a . . . 108m that have been password protected without having access to the password.

### ADDITIONAL EMBODIMENT DETAILS

The described techniques may be implemented as a method, apparatus or article of manufacture involving software, firmware, micro-code, hardware and/or any combination thereof. The term “article of manufacture” as used herein refers to code or logic implemented in a medium, where such medium may comprise hardware logic [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The medium in which the code or logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made without departing from the scope of embodiments, and that the article of manufacture may comprise any information bearing medium. For example, the article of manufacture comprises a storage medium having stored therein instructions that when executed by a machine results in operations being performed.

Certain embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, certain embodiments can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article. The functionality and/or the features of a device may be alternatively embodied by one or more other devices which are not explicitly described as having such functionality/features. Thus, other embodiments need not include the device itself.

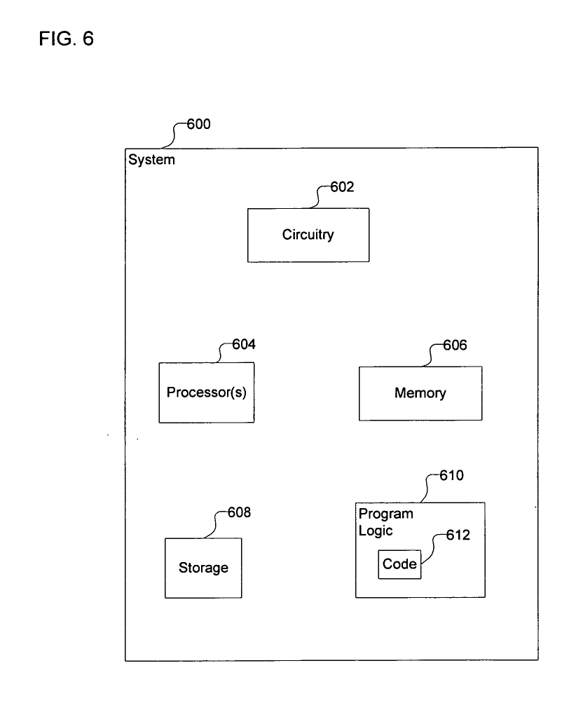

FIG. 6 illustrates a block diagram of the architecture of a system 600 in which certain embodiments may be implemented. In certain embodiments, the storage system 102, and the hosts 104a . . . 104n shown in FIG. 1, may be implemented in accordance with the system 600. The system 600 may include a circuitry 602 that may in certain embodiments include a processor 604. The system 600 may also include a memory 606 (e.g., a volatile memory device), and storage 608. Certain elements of the system 600 may or may not be found in the storage system 102 and the hosts 104a . . . 104n. The storage 608 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 608 may comprise an internal storage device, an attached storage device and/or a network accessible storage device. The system 600 may include a program logic 610 including code 612 that may be loaded into the memory 606 and executed by the processor 604 or circuitry 602. In certain embodiments, the program logic 610 including code 612 may be stored in the storage 608. In certain other embodiments, the program logic 610 may be implemented in the circuitry 602. Therefore, while FIG. 6 shows the program logic 610 separately from the other elements, the program logic 610 may be implemented in the memory 606 and/or the circuitry 602.

Certain embodiments may be directed to a method for deploying computing instruction by a person or automated processing integrating computer-readable code into a computing system, wherein the code in combination with the computing system is enabled to perform the operations of the described embodiments.

At least certain of the operations illustrated in FIGS. 2, 3, 4, and 5 may be performed in parallel as well as sequentially. In alternative embodiments, certain of the operations may be performed in a different order, modified or removed.

Furthermore, many of the software and hardware components have been described in separate modules for purposes of illustration. Such components may be integrated into a fewer number of components or divided into a larger number of components. Additionally, certain operations described as performed by a specific component may be performed by other components.

The data structures and components shown or referred to in FIGS. 1-6 are described as having specific types of information. In alternative embodiments, the data structures and components may be structured differently and have fewer, more or different fields or different functions than those shown or referred to in the figures. Therefore, the foregoing description of the embodiments has been presented for the purposes of illustration and description. It is not intended to be exhaustive or to limit the embodiments to the precise form disclosed. Many modifications and variations are possible in light of the above teaching.

What is claimed is:

1. A method, comprising:
assigning a password corresponding to at least one logical unit in a storage system;
receiving, from a requester, a request to perform an operation on the at least one logical unit;
authenticating the requester for a limited period of time, in response to the requestor providing the assigned password for the at least one logical unit; and
performing the operation on the at least one logical unit, in response to authenticating the requestor.

2. The method of claim 1, wherein the request is generated from within the storage system, wherein the operation is for copying the at least one logical unit, and wherein the limited period of time expires in response to an expiry of a session.

3. The method of claim 1, wherein the request is generated by the requestor from at least one host coupled to the storage system, wherein the operation is for performing input/output (I/O) on the at least one logical unit, and wherein the limited period of time expires in response to an expiry of a session.

4. The method of claim 1, wherein the request is generated from at least one host by the requester, the method further comprising:
maintaining an access control list corresponding to the at least one logical unit, wherein an entry in the access control list is capable of being used to determine whether the at least one host can access the at least one logical unit; and
authenticating the requester for the limited period of time, even if the entry in the access control list has been used to determine that the at least one host is capable of accessing the at least one logical unit.

5. The method of claim 1, further comprising:
generating a plurality of logical units that includes the at least one logical unit in the storage system; and
assigning a single password for a group of logical units selected from the plurality of logical units, wherein the requestor is authenticated for performing operations on the group of logical units by providing the single password.

6. The method of claim 1, wherein the at least one logical unit includes a plurality of logical volumes generated from a plurality of physical volumes that comprise physical storage coupled to the storage system, the method further comprising:
maintaining, in the storage system, a first indicator corresponding to the at least one logical unit, wherein the first indicator indicates whether the password has to be set for the at least one logical unit; and
maintaining, in the storage system, a second indicator corresponding to the at least logical unit, wherein the second indicator includes the assigned password.

7. A system for controlling at least one logical unit, comprising:
memory; and
processor coupled to the memory, wherein the processor is operable to:
(i) assigning a password corresponding to the at least one logical unit;
(ii) receiving, from a requester, a request to perform an operation on the at least one logical unit;
(iii) authenticating the requester for a limited period of time, in response to the requester providing the assigned password for the at least one logical unit; and
(iv) performing the operation on the at least one logical unit, in response to authenticating the requestor.

8. The system of claim 7, wherein the system is a storage system, wherein the request is generated from within the storage system, wherein the operation is for copying the at least one logical unit, and wherein the limited period of time expires in response to an expiry of a session.

9. The system of claim 7, wherein the system is a storage system, wherein the request is generated by the requestor from at least one host coupled to the storage system, wherein the operation is for performing input/output (I/O) on the at least one logical unit, and wherein the limited period of time expires in response to an expiry of a session.

10. The system of claim 7, wherein the request is generated from at least one host by the requester, wherein the processor is further operable to:
maintain an access control list corresponding to the at least one logical unit, wherein an entry in the access control list is capable of being used to determine whether the at least one host can access the at least one logical unit; and
authenticate the requester for the limited period of time, even if the entry in the access control list has been used to determine that the at least one host is capable of accessing the at least one logical unit.

11. The system of claim 7, wherein the processor is further operable to:
generate a plurality of logical units that includes the at least one logical unit in the storage system; and
assign a single password for a group of logical units selected from the plurality of logical units, wherein the requestor is authenticated for performing operations on the group of logical units by providing the single password.

12. The system of claim 7, wherein the system is a storage system, wherein the at least one logical unit includes a plurality of logical volumes generated from a plurality of physical volumes that comprise physical storage coupled to the storage system, and wherein the processor is further operable to:
maintain, in the storage system, a first indicator corresponding to the at least one logical unit, wherein the first indicator indicates whether the password has to be set for the at least one logical unit; and
maintain, in the storage system, a second indicator corresponding to the at least logical unit, wherein the second indicator includes the assigned password.

13. An article of manufacture for controlling at least one logical unit in a storage system, wherein the article of manufacture is capable of causing operations, the operations comprising:
assigning a password corresponding to the at least one logical unit in the storage system;
receiving, from a requester, a request to perform an operation on the at least one logical unit;
authenticating the requestor for a limited period of time, in response to the requester providing the assigned password for the at least one logical unit; and
performing the operation on the at least one logical unit, in response to authenticating the requester.

14. The article of manufacture of claim 13, wherein the article of manufacture is a computer readable medium, wherein the request is generated from within the storage system, wherein the operation is for copying the at least one logical unit, and wherein the limited period of time expires in response to an expiry of a session.

15. The article of manufacture of claim 13, wherein the request is generated by the requestor from at least one host coupled to the storage system, wherein the operation is for performing input/output (I/O) on the at least one logical unit, and wherein the limited period of time expires in response to an expiry of a session.

16. The article of manufacture of claim 13, wherein the request is generated from at least one host by the requester, the operations further comprising:
maintaining an access control list corresponding to the at least one logical unit, wherein an entry in the access control list is capable of being used to determine whether the at least one host can access the at least one logical unit; and
authenticating the requestor for the limited period of time, even if the entry in the access control list has been used to determine that the at least one host is capable of accessing the at least one logical unit.

17. The article of manufacture of claim 13, the operations further comprising:
generating a plurality logical units that includes the at least one logical unit in the storage system; and
assigning a single password for a group of logical units selected from the plurality of logical units, wherein the requestor is authenticated for performing operations on the group of logical units by providing the single password.

18. The article of manufacture of claim 13, wherein the at least one logical unit includes a plurality of logical volumes generated from a plurality of physical volumes that comprise physical storage coupled to the storage system, the operations further comprising:
maintaining, in the storage system, a first indicator corresponding to the at least one logical unit, wherein the first indicator indicates whether the password has to be set for the at least one logical unit;
maintaining, in the storage system, a second indicator corresponding to the at least logical unit, wherein the second indicator includes the assigned password.

19. A method for deploying computing infrastructure, comprising integrating computer-readable code into a computing system, wherein the code in combination with the computing system is capable of performing:
assigning a password corresponding to at least one logical unit in a storage system;
receiving, from a requester, a request to perform an operation on the at least one logical unit;
authenticating the requestor for a limited period of time, in response to the requestor providing the assigned password for the at least one logical unit; and
performing the operation on the at least one logical unit, in response to authenticating the requester.

20. The method of claim 19, wherein the request is generated from within the storage system, wherein the operation is for copying the at least one logical unit, and wherein the limited period of time expires in response to an expiry of a session.
